(19) United States
(12) Patent Application Publication
(10) Pub. No.: US 2026/0320190 A1
(43) Pub. Date: Oct. 15, 2026

(54) ADVANCED FIRMWARE LOCK

(71) Applicant: Absolute Software Corporation, Vancouver (CA)

(72) Inventor: Eugene KHORUZHENKO, Vancouver (CA)

(21) Appl. No.: 19/718,010

(22) Filed: Jun. 24, 2026

Related U.S. Application Data
(63) Continuation of application No. 18/792,972, filed on Aug. 2, 2024.
Application No. 18/792,972 is a continuation of application No. PCT/CA2022/051245, filed on Aug. 16, 2022.
(60) Provisional application No. 63/307,631, filed on Feb. 7, 2022.

(51) Int. Cl. G06F 21/57; G06F 9/4401

(52) U.S. Cl. CPC G06F 21/575; G06F 9/4401; G06F 2221/034; G06F 2221/2103

(57) ABSTRACT

To improve computer security, on every boot or reboot a firmware agent provides a challenge for an OS agent to be used for the subsequent boot. During boot, the response to the previous challenge is checked, as it was provided in advance by the OS agent to a designated mailbox when the device was last switched on. The OS agent may generate a response in either an offline mode or when connected to a server. If the response is correct, the device boots normally. If the response is incorrect, then a firmware lock is engaged. A certain number of grace boots may be allowed without a response being required.

### TECHNICAL FIELD

The present disclosure relates to mobile electronic device security. In particular, it relates to the use of a firmware lock.

### BACKGROUND

Firmware locks are generally considered to be more robust than other types of device lock. However, it may be possible for existing firmware locks to be bypassed by a savvy thief.

One existing firmware lock is based on a report, timer expiry, or hacking attempt. A UEFI (unified extensible firmware interface) agent acts during boot, based on a report stored in the EFI (extensible firmware interface) partition. The report is periodically stored in the partition by an OS (operating system) agent, which receives an instruction from a server periodically. Device rules detect noncompliant use, a theft or lost report, timer expiry or a hacking attempt and automatically cause the device to lock down.

Another solution provides a firmware lock in which the lock command is issued remotely, causing a reboot. A user must wait for a remote unlock command before being able to log in again using established credentials.

Absolute Software currently provides a firmware lock feature that has an offline lock capability. The offline lock can be engaged offline by the Absolute’s Device Freeze^{TM} agent based on a timer expiry or other conditions.

This background is not intended, nor should be construed, to constitute prior art against the invention.

### SUMMARY

On every boot or reboot of an electronic device, a firmware agent provides a challenge for an OS agent for the subsequent boot, i.e. OS agent must correctly respond to the challenge during the current boot session to allow the next boot. During the firmware boot phase, the firmware agent processes the response to its prior challenge: the OS agent provided the prior response to a designated mailbox in the previous boot session, i.e. when the device was last switched on and optionally connected to a monitoring server. If the response is correct, the device boots normally. If the response is incorrect or missing, then the firmware lock is engaged. If in the previous boot session the OS agent was tampered with so that it could not provide a response, in the subsequent session the firmware agent is able to lock the device, so it will not boot until it is unlocked. If the OS agent was tampered with after it already provided the response, the device may boot once more normally, but it will not boot after that. The OS agent may be able to detect tampering attempts and remove the previously provided response prior to becoming inoperable, thus reducing the possibility of an extra normal boot. The OS agent may also choose to write the response at the very end of the session, e.g. as part of OS restart or shutdown procedure, achieving a similar effect.

An analogy is a room that is accessed by a door with a deadlatch lock with dogging. The key can set the door not to lock, corresponding to the electronic device not being equipped with the lock. The key can also set the lock on the door, when open, so that it will lock immediately upon closing, but will otherwise remain open. This corresponds to operation of the electronic device when equipped with the lock. Continued provision of the correct responses will keep the door open, but if a correct response is not provided, the device will lock, and it will not be possible to unlock the device unless a passcode is entered. The passcode is analogous to the key to the door.

Disclosed is a method for securing an electronic device, comprising: a firmware (FW) agent in the electronic device generating, during a boot process of the electronic device, a challenge for an operating system (OS) agent in the electronic device; the OS agent writing a response to the challenge in a mailbox in the electronic device after the boot process is complete; the FW agent checking the response during a subsequent boot process of the electronic device; and the FW agent permitting or preventing completion of the subsequent boot process depending respectively on whether the response is correct or incorrect.

Also disclosed is an electronic device, comprising a processor and non-transient computer-readable media storing a firmware (FW) agent and an operating system (OS) agent as computer-readable instructions, which, when executed by the processor, cause: the FW agent to generate, during a boot process of the electronic device, a challenge for the OS agent; the OS agent to write a response to the challenge in a mailbox in the electronic device after the boot process is complete; the FW agent to check the response during a subsequent boot process of the electronic device; and the FW agent to permit or prevent completion of the subsequent boot process depending respectively on whether the response is correct or incorrect.

Further disclosed is a system comprising a server and an electronic device, the electronic device comprising a processor and non-transient computer-readable media storing a firmware (FW) agent and an operating system (OS) agent as computer-readable instructions, which, when executed by the processor, cause: the FW agent to generate, during a boot process of the electronic device, a challenge for the OS agent; the OS agent to obtain a response from the server; the OS agent to write the response to the challenge in a mailbox in the electronic device after the boot process is complete; the FW agent to check the response during a subsequent boot process of the electronic device; and the FW agent to permit or prevent completion of the subsequent boot process depending respectively on whether the response is correct or incorrect.

This summary does not necessarily describe all the features of the invention in detail and is not intended, nor should it be construed, to limit the invention.

### BRIEF DESCRIPTION OF THE DRAWINGS

FIG. 1 is a schematic block diagram of the system, according to an embodiment of the invention.

FIG. 2 is a flowchart for booting with and without connection to the server, according to an embodiment of the invention.

FIG. 3 is a flowchart for setting up a device for offline response generation, according to an embodiment of the invention.

FIG. 4 is a flowchart for responding to a challenge offline, according to an embodiment of the invention.

### DETAILED DESCRIPTION

### A. Glossary

BIOS – Basic input-output system

CPU – Central processor unit

Digest – A hash

DPAPI – Data Protection Application Programming Interface

DXE – Driver execution environment. This is the third phase of the UEFI boot process. During the DXE, drivers install boot services and runtime services. In the DXE, the UEFI loads drivers for configured devices, mounts drives, and finds and executes the boot code. After control is transferred to the boot OS, runtime services stay resident to handle OS to UEFI calls and boot services are terminated.

EFI – Extensible firmware interface

FW – Firmware

HDD – Hard disk drive

Lock message – a communication that includes an unlock passcode hash and optionally an offline lock hash and other parameters. If an offline lock hash is provided in the lock message, then it causes a pre-lock action, otherwise a lock action is caused.

Lock action – a device is locked immediately after receiving a lock message that does not include an offline lock hash.

Mailbox - an area within firmware, such as a UEFI variable, which is accessible both to the firmware agent and the OS agent. Mailbox content may be authenticated in the DXE phase of booting.

Module - any component in this invention and to any or all of the features of the invention without limitation. A module may be a software, firmware or hardware module.

NVRAM – Non-volatile random access memory

OEM – Original equipment manufacturer

Offline lock code – A code that causes a device to lock. For example, the lock may be a firmware lock that is triggered by the offline lock code. This may occur when it is not possible to receive an instruction from a server. An OS agent knows or generates the offline lock code for locking the device.

Offline lock hash – A hash of the offline lock code.

OS - Operating system

Pre-lock action – an electronic device is primed for locking, but not actually locked, after receiving a lock message that includes the offline lock hash. The presence of an offline lock hash tells the firmware agent to save message parameters and be ready to engage the lock when certain conditions are met. The lock itself may therefore be considered to be primed.

Response – proof that the responder knows the secret. For example, a hash of the secret is used in calculation of a digest of the response message, so neither the secret nor the secret’s hash is transmitted back to the challenger. The challenger has to calculate the hash of the secret and the response digest in the same way as the responder and then check if the digests match.

RO - Read-only

Secret – a code that only the challenger and responder know (e.g. random number or nonce).

Session – a period between CPU reset, when the session starts, and the moment it is switched off or restarted. A session consists of the following phases, in the time order:
a. Firmware Boot Phase – a period between CPU reset, when firmware boot starts, and the moment the firmware passes control to the OS bootloader. The firmware agent is executed during the trusted portion of the firmware boot.
b. OS Execution Phase – a period between start of the OS bootloader and the moment of OS restart or shutdown. The OS agent is loaded during the startup portion of OS execution phase and remains active and communicating with the server up to the end of the session.

A session may include periods when the electronic device is partially powered down, for example, when it is in a sleep mode or hibernation mode.

Subsequent - When used to refer to a later event of multiple events, this means an event immediately following another of the events.

TLS – Transport Layer Security

TPM – Trusted platform module

UEFI – Unified extensible firmware interface

Unlock passcode – rather than a password, this is auto-generated by the server (not the user) and is not a word or phrase, but an array of random bytes, i.e. codes.

Unlock passcode hash – This is a hash of the unlock passcode that can be used to unlock a device in which the firmware lock has been triggered.

### B. Exemplary Embodiments

The presently disclosed solution uses an active challenge/response mechanism to keep an electronic device unlocked, otherwise it automatically locks. During setup, which may require one or more boot cycles, the server sends to the device a secure lock message, with includes an unlock passcode hash and an offline lock hash. The device may be considered to be primed, i.e. in a pre-lock state or lock-ready state, and operates normally when it has access to the response to the challenge. It is also ready to lock if an OS agent sends a secret offline lock code to the firmware lock module.

On every boot, the firmware agent generates a challenge to which only a server or OS agent that has the corresponding secret is able to generate a proper response. The challenge is a single-use challenge based on, for example, a high quality nonce, and the response is a corresponding, single-use response. The response is written by the OS agent into a designated mailbox in every session (i.e. period) that the device is switched on, i.e. before the device resets. The mailbox may be, for example, a regular UEFI variable in NVRAM. For example, as soon as the OS agent starts to operate, it may write the response to the mailbox, if it has it, or it will receive the response from the server and then write it to the mailbox. Upon the following boot (e.g. at CPU reset), the firmware agent validates the response, and if it is correct, booting continues normally; otherwise, the firmware lock is engaged.

In other embodiments, the mailbox may be replaced by a file in the EFI partition, a hardware register, a TPM memory, or any other non-secure, non-volatile storage area accessible by both the OS and the firmware agent.

For cases where the device is used offline and must obtain the response from the server, there may be a grace number of reboots permitted without the response needing to be provided. This is so that the device does not lock each time it is used offline. A skip counter is used to count the number of times that the device is rebooted without a response. However, certain sensitive devices may be required to connect in each session to avoid being locked. If the device locks up inadvertently due to too many reboots offline with no response, it is possible to unlock the device knowing the unlock passcode, for which the hash is stored in a location accessible to the firmware lock.

During the UEFI DXE phase, the FW agent loads, generates a nonce (used as secret) to produce a challenge, and the nonce hash is saved in FW NVRAM for future verification. This is similar to the process described in patent application PCT/CA2018/051064 entitled Secure Firmware Interface. Then, there may be other FW agent steps such as verification of a previous challenge, other tasks such as communicating with the server or other FW components, etc. Normally, on boot, the OS boots, the OS agent starts, the OS agent looks at the challenge, the OS agent communicates with the server, the server produces a response, the OS agent writes the response to the mailbox, and then the device reboots. During a session, all this happens in this order. Then, on the next boot, the FW agent generates a new challenge, and then validates the result of the previously saved response in the mailbox in order to make a decision whether to continue to boot or not.

If booting is not continued, then the device needs to be unlocked. After unlocking, a challenge is again generated by the firmware ahead of the corresponding response that will be checked on the following boot.

If the requirement for a challenge/response with the server in every session to keep the device unlocked is too strict, the solution can be further enhanced with a separate secret between the firmware agent and the OS agent, so that the OS agent can respond without it having to connect to the server. This is less secure as the secret has to be stored on the device. In one possible protocol, the firmware agent generates a separate key pair, saves the public key as a firmware variable, encrypts the private key, and sends it to the server via Absolute’s Secure Interface^{TM} (see patent application PCT/CA2018/051064). This may use a separate mailbox so as not to block other secure messages that might be being delivered to the device from the server. The server has the encryption key that the firmware agent encrypted the private key with, uses it to decrypt the private key, and then sends the decrypted private key to the OS agent via TLS (Transport Layer Security). The OS agent saves the private key in the HDD (Hard Disk Drive) or registry, protected via the DPAPI (Data Protection Application Programming Interface). From this point on, the firmware agent generates challenges of random data, saves their hash, and encrypts the random data with the public key. Then, the OS agent decrypts the encrypted random data with the private key, hashes the random data, and then, as the response, sends the random data hash back to the firmware agent, signed with the private key. By saving the private key securely in the OS, only the logged-in user or admin user has access to it, and not a hacker. The firmware agent validates the signing of the response and compares the saved random data hash with the one received from the OS agent.

If the private key were to be stored directly by the firmware agent so that it were accessible by the OS agent, this would be insecure because it would occur over a channel that is exposed to hacking.

To further improve security, the previously mentioned secret can be stored in a TPM (Trusted Platform Module).

It is possible to prevent the device being hacked by a physical attack using a flash programmer. For example, a hacker may try to find the lock bit in the firmware flash and clear it. This will be impossible if the device manufacturer (OEM) implements Absolute’s Secure Storage^{TM} specification, which is an interface that redirects writes of firmware variables from the default location (main BIOS flash) to an OEM-implemented secure storage location.

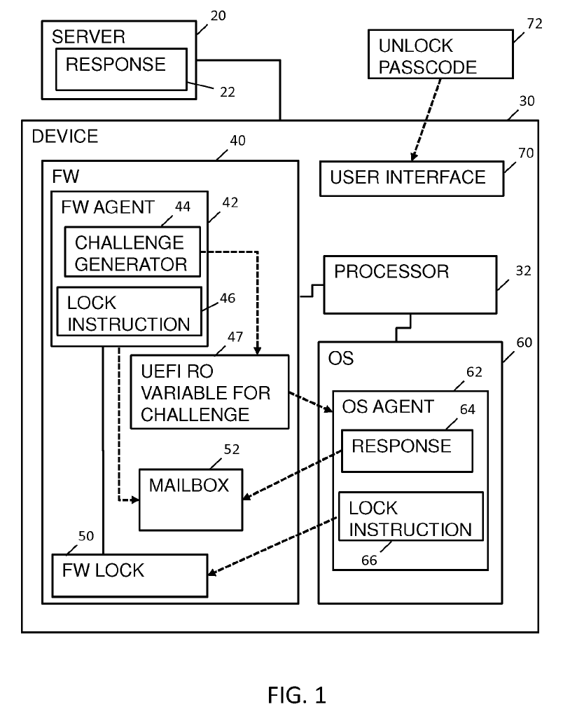

FIG. 1 is a schematic block diagram of an exemplary embodiment of a system that provides a firmware lock, showing the main modules. A server 20, which has a response 22 or the capability to generate a response after receiving a challenge, is connectable via one or more communication networks to a device 30. Device 30 is an electronic device such as, without limitation, a laptop, a tablet, a smartphone or a desktop. Device 30 includes one or more processors 32 operably connected to firmware 40, an OS 60 and a user interface 70. The firmware 40 includes a FW agent 42, which includes a challenge generator 44 and a lock instruction 46. The challenge generator stores the challenge in a UEFI read only variable 47. The lock instruction 46 activates the FW lock 50. The FW agent is connected to a mailbox 52 in which a response to the generated challenges can be received. The OS 60 has an OS agent 62 that runs when the OS is operative. The OS agent 62 has a response 64, access to a response or the ability to generate a response. The OS agent 62 also includes another lock instruction 66, which it may send to the FW lock 50 at any time depending on situations detected by the OS agent. If the FW lock 50 is triggered, the firmware 40 is prevented from booting to the OS, thereby locking the device 30. The device 30 may be unlocked by a user entering an unlock passcode 72 via the user interface 70 when the device is part way through booting. The device 30 may also be unlocked by other means, such as via the BIOS-level network stack, disk, etc., using various means of delivery of the unlock passcode to the FW agent.

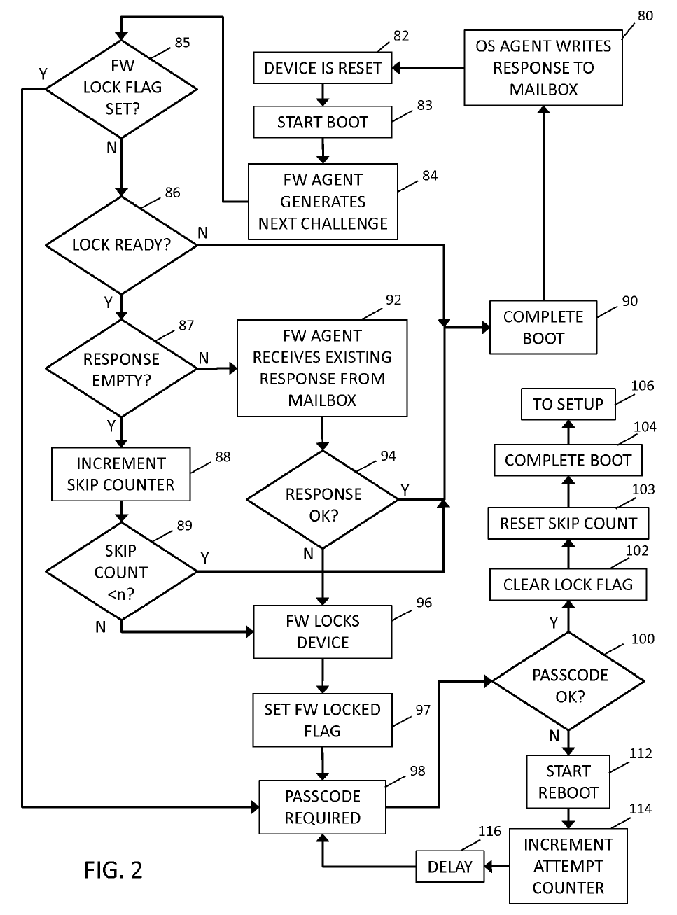

FIG. 2 is a flowchart for booting with and without connection to the server. Assuming to start with that the lock system is fully set up and the device has booted, then, in step 80, the OS agent writes to the mailbox a response to the challenge generated by the firmware agent during the current session, for example at the beginning of the current session. It is done in anticipation that the firmware agent will verify this response in the subsequent session and allow the OS to boot again. At the end of the current session, in step 82, the device is reset, and it starts to boot in step 83. In this subsequent session, the firmware agent generates a new challenge in step 84, requiring a new response from the OS agent to eventually continue operation of the device in another subsequent session.

The FW agent generates a new nonce/challenge on every boot in step 84, regardless of the result of operation on the previous boot. The firmware agent passes the challenge to the OS agent using a read-only UEFI variable. This is so that the challenge is always ready for the OS agent or server to read; on a very first boot after setup, and after a period offline. If the generation of a challenge were to be skipped when the device is offline, then on the very next online boot the server will not have a challenge and will not be able to produce a response.

In step 85, the FW agent checks a FW lock flag, which indicates whether the FW lock has been triggered during a previous boot. If the FW lock flag is not set, then the process continues to step 86. If the FW lock is active, which is indicated by the FW lock flag being set, then the process jumps to step 98, in which the entry of a passcode is required to complete the boot.

In step 86, a check is made to see if the lock of the device is primed, i.e. to check whether the lock is ready to be used. This is assuming that the challenge mechanism is already set up (keys generated, stored, etc.). If the FW is not locked, and not lock-ready, then the process proceeds to step 90 in which the boot is completed normally. In step 86, there may be more to check, such as the setup step, including configuration of the advanced FW lock. For example, the lock message may require the offline challenge to be disabled. The process may loop round the above steps (80-90) as many times as necessary to set up the lock so that the device is in a lock-ready state.

If the lock is ready, or primed, the FW agent checks whether the existing response variable is empty in step 87. The response variable is the read-only UEFI variable in the mailbox. If the response variable is empty, then in optional step 88 a skip counter is incremented, which occurs when the device is not connected to the server. In optional step 89, which also occurs when the device is not connected to the server, the skip counter is checked to determine whether the skip count is below a preset level (n). Step 89 may also occur if the OS agent has been removed or is disabled so that it cannot produce a response. If the skip count is within the limit, then the process proceeds to step 90, in which the booting is completed. At this point, the device is fully operational without needing a connection to the server. While this session is active, the process reverts to step 80 in preparation for the following session.

If, however, the skip count in step 89 has reached the limit (n), then in step 96 the FW agent activates the FW lock. In strict environments, where no grace number of reboots without a response is permitted, the skip count check in step 89 is removed (or the limit n is set to 0). In this case, the empty response (from step 87) causes the process flow to go straight to step 96 to lock the device.

If the response variable is not empty in step 87, meaning that a prior response from the OS agent is present, then in step 92, the FW agent receives the existing response from the mailbox. This response should be the response that the OS agent previously provided, in the last session. If the response is correct in step 94, then the device completes booting in step 90. If the response is not correct, or non-existent, then in step 96 the FW agent activates the FW lock. In step 97, the FW agent sets a flag in a FW storage location to indicate that the FW is locked. This is the flag that is checked in step 85. The device then requires the entry of an unlock passcode in step 98 in order to unlock the device and complete booting. If a correct unlock passcode is received in step 100, this unlocks the device, i.e. the lock flag is cleared in step 102, unlock and offline hashes are cleared, the skip count is reset to zero in step 103, etc., in preparation for the next lock message. As the lock is disabled, the device continues booting in step 104.

After step 104, the FW lock feature is reengaged after the device is set-up again in step 106, by receiving a secure lock message that primes the device lock with new hashes and other parameters). During setup the server sends to the device a secure lock message, with includes an unlock passcode hash and an offline lock hash. The device may be considered to be pre-locked, but operates normally when it has access to the response to the challenge. It is also ready to lock if an OS agent sends a secret offline lock code to the firmware lock module.

In step 100, if the passcode is incorrect or not entered, then the process triggers the start of a reboot in step 112. Also optionally, the device may increment, in step 114, an attempt counter that counts the number of times the entered passcode is incorrect. Further, the device may optionally introduce a delay in step 116 before requesting the passcode be entered in step 98, the delay increasing as the counter increases, or increasing after a configurable number of attempts has been reached.

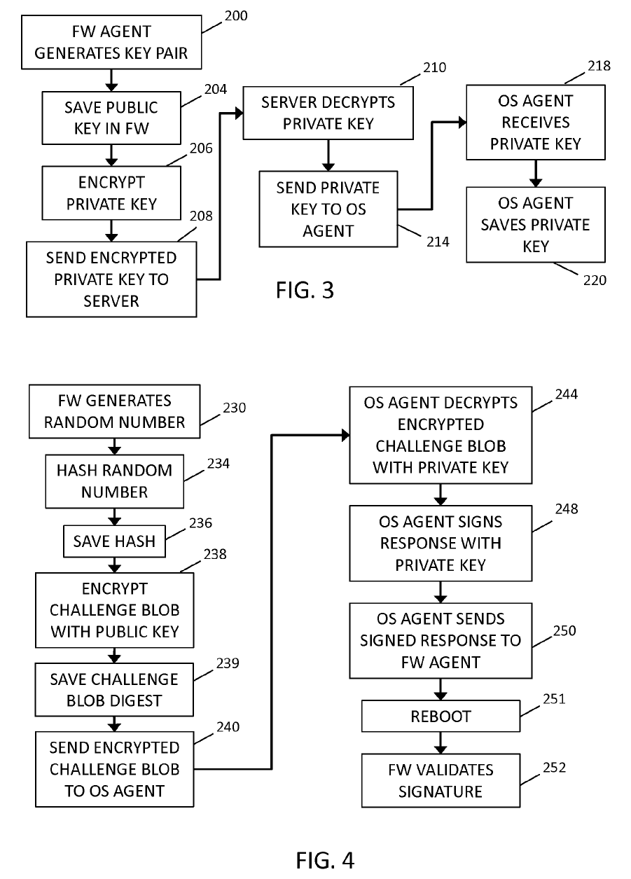

While locking a device that is online can be achieved using a signed, simple plain-text lock instruction from a server, such a signed instruction from the server cannot be delivered when the device is offline. FIG. 3 is a flowchart for an exemplary way of setting up a device for offline response generation. In step 200, a public-private key pair is generated by the FW agent. This is after the FW agent receives a secure command to prime the lock of the device, lock/unlock hashes, configuration settings, etc. during setup. If the lock configuration requests the offline response generation then this sub-feature (the offline lock) is enabled. In step 204, the public key is saved in the FW. In step 206, the FW agent encrypts the private key. In step 208, the FW agent sends the encrypted private key to the server. In step 210, the server decrypts the private key. In step 214, the server sends the decrypted private key to the OS agent over an encrypted TLS channel. In step 218, the OS agent receives the decrypted private key over the encrypted TLS channel. In step 220, the OS agent saves the private key in secure storage provided by the OS. The public/private key pair is saved during the pre-lock setup phase (priming phase), and neither of them are sent in a challenge/response communication. In this embodiment there are secure links between the FW agent and the server, and between the server and the OS agent, but there is no initial secure connection between FW agent and the OS agent. Thus, the process of FIG. 3 is to establish the secure connection between the FW agent and the OS agent, which is needed for offline communication.

Alternately, the key pair is generated on the server side, rather than by the firmware. The server synchronously sends the signed public portion to the firmware as part of the pre-lock procedure, and also sends the private portion over an encrypted TLS channel to the agent. This eliminates the need for the FW to send the private key via the server to the agent. It is also useful for the server to manage the key pair, because the server can periodically refresh expired keys and send the new ones to the FW and OS agents. While possible, the key refresh may be cumbersome if initiated from the firmware side.

FIG. 4 is a flowchart for responding to a challenge when the device is offline. In step 230, the FW agent generates a random number (i.e. random nonce or secret), hashes it in step 234, saves the hash for later verification in step 236, and encrypts a challenge blob derived from the random number in step 238 using the public key. Adding more status information to the random nonce results in a challenge blob. The FW agent then saves a digest of the challenge blob in step 239. The FW takes a hash (digest) of the plain-text challenge blob and saves the hash for the future verification of a response. The FW agent sends the encrypted challenge blob (or "challenge") to the OS agent in step 240. When signing a message, the signature is generated from a short message digest (hash). The encrypted challenge blob, or simply challenge, is passed in a read-only variable to the OS agent. The challenge blob may include additional information that the firmware wants to send to the agent, such as the number of skipped challenges and other status information.

The OS agent, having already received the private key, once, upon the pre-lock setup, uses it until a lock/unlock occurs, or the server deactivates the offline response feature or updates the key pair. In step 244, the OS agent decrypts the encrypted challenge blob with the private key and gets the plain-text challenge blob. The OS agent takes its digest same way as the FW agent did. Then the OS agent generates a response, i.e. some information to pass back to the FW agent, e.g. an “OK” string, timestamp, etc. To sign this message the message is hashed, and a hash of the original challenge blob, which had the secret, is added. In this way, the response digest includes the digest of the secret, or it could be said that secret was used to generate the response digest. In step 248, the OS agent signs the response, using the decrypted secret (i.e. the random number) when generating the digest. In step 250 the OS agent sends the signed response to the FW agent.

Steps 230 to 240 are executed in FW, during which the encrypted challenge is put in a read-only UEFI variable. After this, the OS is started, the OS agent loads and the process advances to step 244. All steps are sequential in one boot until step 250, where the response is written to a mailbox. There is a reboot 251 after step 250, in order to go back to operating from the FW to validate the response and take action. In step 252, in the FW, the FW agent validates the signature of the signed response, using the previously saved digest of the challenge blob. When the FW validates the response signature, it takes a hash of the response message (the “OK” string) and adds the hash of the challenge saved earlier. The resulting digest should be the same as was calculated by the OS agent when it generated the signature. Therefore, when the FW agent calculates the signature of this digest with the public key, it should match.

If signature validation succeeds, then the device completes booting, but if not, the device waits for the input of an unlock passcode. If the signature validation fails, the device lock is triggered, which is a significant change of state. When locked, the unlock passcode or other unlock mechanism is needed, following which an unlock process is performed.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. In general, unless otherwise indicated, singular elements may be in the plural and vice versa with no loss of generality. Accordingly, the specification is to be regarded in an illustrative, rather than a restrictive, sense.

The detailed description has been presented partly in terms of methods or processes, symbolic representations of operations, functionalities and features of the invention. A software and firmware implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. The processes described herein may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

Where a processor has been described, it may include two or more constituent processors. Computer readable memories may be divided into multiple constituent memories, of the same or a different type. In some embodiments, the steps in the flowcharts and other diagrams may be performed in a different order, steps may be eliminated or additional steps may be included, without departing from the invention. Modules may be combined or divided into constituent modules.

It will be clear to one having skill in the art that further variations to the specific details disclosed herein can be made, resulting in other embodiments that are within the scope of the invention disclosed. All configurations described herein are examples only and actual ones depend on the specific embodiment. Accordingly, the scope of the invention is to be construed in accordance with the substance defined by the following claims.

1. A method for securing an electronic device, comprising:
a firmware (FW) agent in the electronic device generating, during a boot process of the electronic device, a challenge for an operating system (OS) agent in the electronic device;
the FW agent checking, during the boot process, that a prior response in a mailbox in the electronic device is correct, the prior response having been written to the mailbox prior to a start of the boot process;
the OS agent writing a response to the challenge in the mailbox after the boot process is complete;
the FW agent checking the response during a subsequent boot process of the electronic device; and
the FW agent permitting or preventing completion of the subsequent boot process depending respectively on whether the response is correct or incorrect,
wherein the method further comprises:
the FW agent receiving a public key of a key pair from a server; and
the OS agent receiving a private key of the key pair from the server.

2. The method of claim 1, comprising prior to the OS agent writing the response:
the FW agent permitting completion of the boot process.

3. The method of claim 1, comprising, after the completion of the subsequent boot process:
the FW agent determining that there is no response in the mailbox during another boot process of the electronic device; and
the FW agent preventing completion of the other boot process.

4. The method of claim 1, comprising, after the completion of the subsequent boot process:
the FW agent determining that there is no response in the mailbox during another subsequent boot process of the electronic device;
the FW agent checking a number of consecutive times that the electronic device has started to boot with no response in the mailbox; and
the FW agent permitting or preventing completion of the other subsequent boot process depending respectively on whether the number is below or has reached a limit.

5. The method of claim 1, comprising, after preventing the completion of the subsequent boot process:
the FW agent receiving a correct passcode; and
in response, the FW agent then permitting the completion of the subsequent boot process.

6. The method of claim 1, comprising the OS agent obtaining the response from a server.

7. The method of claim 1, comprising the OS agent writing the response prior to the subsequent boot process starting and:
as soon as the OS starts to operate; or
upon receiving the response from a server; or
at an end of a session; or
during a shut-down procedure of the electronic device.

8. The method of claim 1, comprising:
the FW agent encrypting the challenge using the public key;
the OS agent decrypting the challenge using the private key;
the OS agent signing the response with the private key;
the electronic device starting the subsequent boot process; and
the FW agent validating a signature of the signed response during the subsequent boot process.

9. The method of claim 1, comprising, prior to the boot process, setting up the electronic device so that a correct response is in the mailbox.

10. An electronic device, comprising:
a processor; and
non-transient computer-readable media storing a firmware (FW) agent and an operating system (OS) agent as computer-readable instructions, which, when executed by the processor, cause:
the FW agent to generate, during a boot process of the electronic device, a challenge for the OS agent;
the FW agent to check, during the boot process, that a prior response in a mailbox in the electronic device is correct, the prior response having been written to the mailbox prior to a start of the boot process;
the OS agent to write a response to the challenge in the mailbox after the boot process is complete;
the FW agent to check the response during a subsequent boot process of the electronic device; and
the FW agent to permit or prevent completion of the subsequent boot process depending respectively on whether the response is correct or incorrect,
wherein the computer-readable instructions, when executed by the processor, further causes:
the FW agent receiving a public key of a key pair from a server; and
the OS agent receiving a private key of the key pair from the server.

11. The electronic device of claim 10, wherein the mailbox is a unified extensible firmware interface (UEFI) variable, a file in an extensible firmware interface (EFI) partition, a hardware register, or a trusted platform module (TPM) memory.

12. The electronic device of claim 10, wherein the computer-readable instructions, when executed by the processor, cause the OS agent to:
obtain the response from the server; or
generate the response using the private key, for which the FW agent has the public key.

13. A system comprising:
a server; and
an electronic device, the electronic device comprising:
a processor; and
non-transient computer-readable media storing a firmware (FW) agent and an operating system (OS) agent as computer-readable instructions, which, when executed by the processor, cause:
the FW agent to generate, during a boot process of the electronic device, a challenge for the OS agent;
the FW agent to check, during the boot process, that a prior response in a mailbox in the electronic device is correct, the prior response having been written to the mailbox prior to a start of the boot process;
the OS agent to obtain a response from the server;
the OS agent to write the response to the challenge in the mailbox after the boot process is complete;
the FW agent to check the response during a subsequent boot process of the electronic device; and
the FW agent to permit or prevent completion of the subsequent boot process depending respectively on whether the response is correct or incorrect,
wherein the computer-readable instructions, when executed by the processor, further causes:
the FW agent receiving a public key of a key pair from a server; and
the OS agent receiving a private key of the key pair from the server.
